(19) United States
(12) Patent Application Publication
(10) Pub. No.: US 2025/0131553 A1
(43) Pub. Date: Apr. 24, 2025

(54) METHOD FOR DETECTING DEFECT IN TOP COVER OF HYDRO TURBINE BASED ON IMPROVED YOLOV8 MODEL

(71) Applicants: China Yangtze Power Co.,Ltd., Wuhan (CN); Wuhan Digital Design and Manufacturing Innovation Center Co.,Ltd., Wuhan (CN)

(72) Inventors: Tao Wu, Wuhan (CN); Zaiming Geng, Wuhan (CN); Ming Ma, Wuhan (CN); Jian Deng, Wuhan (CN); Wei Qiu, Wuhan (CN); Hui Liu, Wuhan (CN); Jiahao Zhang, Wuhan (CN); Jie Yang, Wuhan (CN); Xiangyou Ye, Wuhan (CN); Xiaoping Zhang, Wuhan (CN); Yiming Ren, Wuhan (CN)

(21) Appl. No.: 18/892,359

(22) Filed: Sep. 21, 2024

(30) Foreign Application Priority Data
Oct. 19, 2023 (CN) 2023113591225

(51) Int. Cl. G06T 7/00; G06V 10/764; G06V 10/80; G06V 10/82

(52) U.S. Cl. CPC G06T 7/0004; G06V 10/764; G06V 10/806; G06V 10/82; G06T 2207/20081; G06T 2207/20084; G06T 2207/20132; G06T 2207/20221

(57) ABSTRACT

Since defect areas in collected hydro turbine defect images account for a small proportion and there is a significant color difference between surrounding background and defects, which creates too much redundant information and greatly affects detection speed, a method for detecting defects in a hydro turbine top cover based on an improved YOLOv8 model involves first cropping collected defect images to obtain cropped images, then expanding the cropped images by image enhancement techniques such as image flipping and image blurring to obtain a training dataset. A defect detection network based on YOLOv8-CBAM is constructed and trained to generate a defect detection model for detecting the defects in the hydro turbine top cover. The method achieves high precision in defect detection for the hydro turbine top cover.

### CROSS-REFERENCE TO RELATED APPLICATION

This application claims priority to Chinese Patent Application No. 202311359122.5, filed on Oct. 19, 2023, which is herein incorporated by reference in its entirety.

### TECHNICAL FIELD

The disclosure relates to the field of target detection, and more particularly to a method for detecting defects in a hydro turbine top cover based on an improved you-only-look-once version 8 (YOLOv8) model.

### BACKGROUND

A top cover, as one of the most important flow-through components of a hydro turbine generator unit, is subjected to long-term cavitation erosion by water flow during unit operation. Multiple cavitation pits may form on a flow surface, result in a great safety hazard to the unit operation. Therefore, it is necessary to arrange maintenance personnel to inspect and repair defective parts of the top cover of the hydro turbine, with repair methods including grinding, welding, and cladding etc. However, a repair area of the top cover spans a large area, and relying on defect detection methods in the related art is very inefficient. Therefore, there is an urgent need to research a method to assist the maintenance personnel in identifying defects in the hydro turbine.

In recent years, using object detection technologies in computer vision to detect surface defects of the top cover of the hydro turbine and measure sizes of molten pools has increasingly attracted attention of researchers. Methods based on the computer vision become an important means of assisting the maintenance personnel in inspecting the top cover of the hydro turbine. Therefore, it is necessary to design a method for detecting the defects in the top cover of the hydro turbine based on an improved YOLOv8 model to solve the aforementioned problems.

### SUMMARY

A purpose of the disclosure is to provide a method for detecting defects in a hydro turbine top cover based on an improved YOLOv8 model, which solves technical problem of accurately detecting surface defects on the hydro turbine top cover.

To solve above problem, the technical solution of the disclosure is as follows.

The method for detecting the defects in the hydro turbine top cover based on the improved YOLOv8 model includes following steps:
S1, processing hydro turbine top cover defect images which are collected to obtain a hydro turbine top cover defect data set;
S2, dividing the hydro turbine top cover defect data set into a train set, a validation set and a test set based on a ratio of 6:2:2;
S3, constructing a network model for detecting the defects in the hydro turbine top cover based on YOLOv8-convolutional block attention module (YOLOv8-CBAM);
S4, training the network model for detecting the defects in the hydro turbine top cover based on the YOLOv8-CBAM, specifically including:
   inputting the hydro turbine top cover defect data set in the step S1 into the network model for training, where a total loss function of the network model includes: a binary cross-entropy (BCE) loss, a distance-weighted flight (DFL) loss, and a complete intersection over union (CIOU) loss, and a calculation formula of the total loss function is as follows:

$$LOSS = {λ}_{1} {LOSS}_{BCE} + {λ}_{2} {LOSS}_{DFL} + {λ}_{3} {LOSS}_{CIOU}$$

where LOSS_{BCE} represents a classification loss, LOSS_{DFL} represents a localization loss, LOSS_{CIOU} represents another localization loss, λ₁ represents a weight of the BCE loss in a total loss for the classification loss, λ₂ represents a weight of the DFL loss in the total loss for the localization loss, and λ₃ represents a weight of the CIOU loss in the total loss for the another localization loss;
S5, generating the improved YOLOv8 model after the step S4; and
S6, detecting the defects in the hydro turbine top cover based on the improved YOLOv8 model.

In an embodiment, in the step S1, the processing hydro turbine top cover defect images includes:
cropping the hydro turbine top cover defect images which are taken on-site to obtain cropped images, and expanding the cropped images by image enhancement techniques to obtain the hydro turbine top cover defect data set.

In an embodiment, in the step S3, the network model for detecting the defects in the hydro turbine top cover based on the YOLOv8-CBAM includes: a backbone network, a neck network and a head network.

In an embodiment, in the step S3, the backbone network is configured to extract features from input images to obtain feature maps, and the backbone network includes five convolution-batch normalization-sigmoid (CBS) modules, four cross stage partial network fusion (C2f) modules and a spatial pyramid pooling fast (SPFF) module;
the neck network is configured to perform multi-scale feature fusion on the feature maps to obtain fused features and send the fused features to the head network, and the neck network includes five CBS modules, six C2f modules, three unsampling (UnSample) modules, six concatenation (ConCat) module and a CBAM module; and
the head network is configured to predict the input images, and the head network includes four detection heads.

Each CBS module is a combination of convolution-batch normalization-activation functions, and a most basic operation unit in the network model, and each CBS module is configured to extract and process features.

Each C2f module is a cross-scaling path structure, a lightweight module, and a main component of the backbone network and the neck network in the network model, and each C2f module is configured to enhance a gradient flow and multi-scale information of features.

Each ConCat module is a feature concatenation operation module, and configured to fuse features of different levels to adapt to target detection of different scales.

Each UnSample module is an upsampling operation module, and configured to scale low-resolution feature maps to high resolution, thereby to perform finer target detection.

The SPFF module is a spatial pyramid structure, and is configured to multi-scale pool feature maps to enhance a receptive field and robustness of features.

The CBAM module is a convolutional attention mechanism module, and is configured to adaptively adjust feature maps in both spatial and channel dimensions to improve performance and generalization ability of the network model.

The method for detecting the defects in the hydro turbine top cover based on the improved YOLOv8 model provided by the disclosure has the following beneficial effects.

The method first performs image cropping on collected defect images, and then uses the image enhancement techniques such as image flipping and image blurring to expand original data. Processed images are used as a train dataset. A defect detection network based on the YOLOv8-CBAM is constructed and then trained to generate a defect detection model. The defect detection model is used to detect the defects in the hydro turbine top cover, offering high precision and efficiency in defect detection.

### BRIEF DESCRIPTION OF DRAWINGS

FIG. 1 illustrates a flow chart of a method for detecting defects in a hydro turbine top cover of the disclosure.

FIG. 2 illustrates a schematic diagram of a YOLOv8-CBAM model of the disclosure.

FIG. 3 illustrates a schematic diagram of a CBAM module of the disclosure.

FIG. 4 illustrates a schematic diagram of a CBS module of the disclosure.

FIG. 5 illustrates a schematic diagram of a C2f module of the disclosure.

FIG. 6 illustrates a schematic diagram of a Bottleneck module of the disclosure.

FIG. 7 illustrates a schematic diagram of a SPFF module of the disclosure.

### DETAILED DESCRIPTION OF EMBODIMENTS

### Embodiment 1

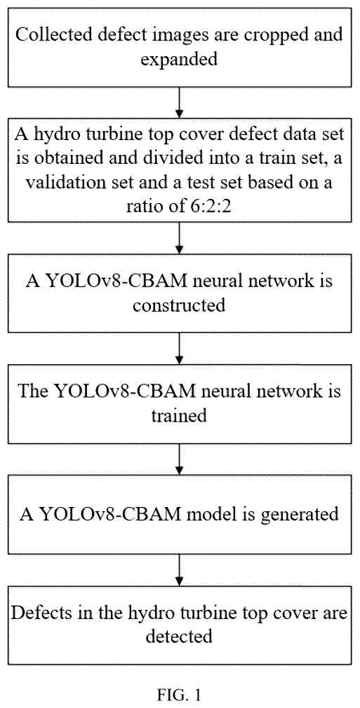

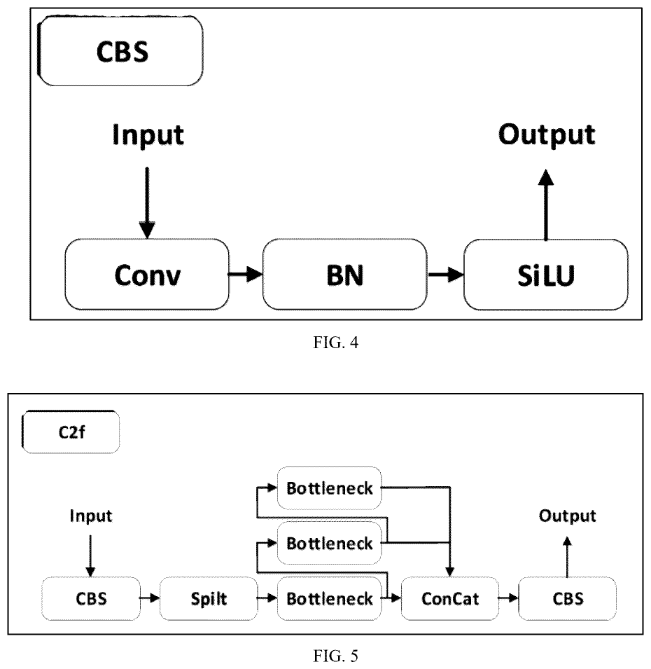

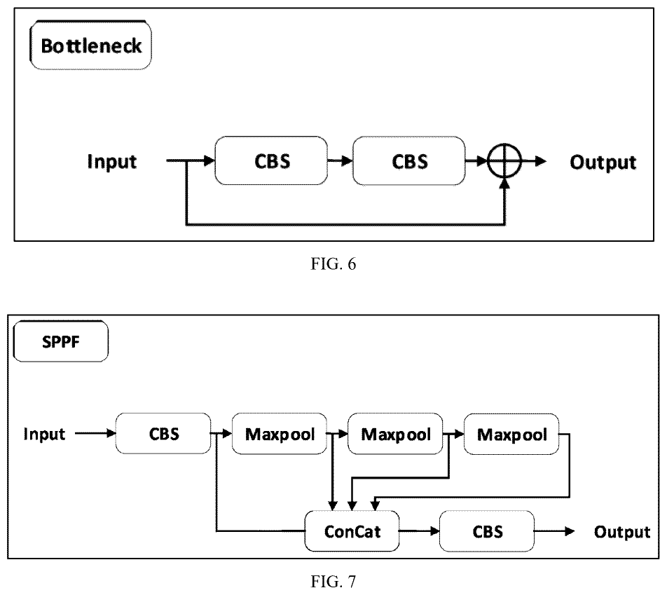

Referring to FIG. 1 to FIG. 7, a method for detecting defects in a hydro turbine top cover based on an improved YOLOv8 model includes the following steps S1-S6.

S1, hydro turbine top cover defect images which are collected are processed to obtain a hydro turbine top cover defect data set.

Furthermore, in the embodiment, crack defects and cavitation defects are selected as research objects for hydro turbine defect detection. Related images captured by maintenance personnel on-site (i.e., the hydro turbine top cover defect images) are used as an original image data set, which includes multiple images of the crack defects and the cavitation defects. Firstly, the original image data set is processed with image cropping to obtain images with uniform resolution. Then, the images with the uniform resolution are expanded by image enhancement techniques including image flipping, mirroring, rotation, scaling, motion blur, and random noise, to obtain an expanded image dataset. Each image of the expanded image dataset is annotated by a Labelme annotation tool to ultimately obtain multiple images and their corresponding label files, i.e., obtain the hydro turbine top cover defect data set.

S2, the hydro turbine top cover defect data set is divided into a train set, a validation set and a test set based on a ratio of 6:2:2.

S3, a network model for detecting the defects in the hydro turbine top cover based on YOLOv8-CBAM is constructed. The network model includes a backbone network, a neck network and a head network.

S4, the network model for detecting the defects in the hydro turbine top cover based on the YOLOv8-CBAM is trained. A training process specifically includes the following step.

The hydro turbine top cover defect data set is input into the network model for training. A total loss function of the YOLOv8-CBAM model includes: a BCE loss, a DFL loss, and a CIOU loss, and a calculation formula of the total loss function is as follows:

$$LOSS = {λ}_{1} {LOSS}_{BCE} + {λ}_{2} {LOSS}_{DFL} + {λ}_{3} {LOSS}_{CIOU} ,$$

where LOSS_{BCE} represents a classification loss, LOSS_{DFL} represents a localization loss, LOSS_{CIOU} represents another localization loss, λ₁ represents a weight of the BCE loss in a total loss for the classification loss, λ₂ represents a weight of the DFL loss in the total loss for the localization loss, and λ₃ represents a weight of the CIOU loss in the total loss for the another localization loss.

S5, the improved YOLOv8 model is generated after the step S4. Trained network weights are saved to generate a defect detection and weld pool size measurement network model, which is configured to detect surface defects of the hydro turbine top cover and measure weld pool sizes.

S6, the defects in the hydro turbine top cover are detected based on the improved YOLOv8 model.

Preferably, in the step S1, a method for processing the hydro turbine top cover defect images includes following steps: the hydro turbine top cover defect images which are taken on-site are cropped to obtain cropped images, and the cropped images are expanded by the image enhancement techniques to obtain the hydro turbine top cover defect data set.

Preferably, in the step S3, the backbone network is configured to extract features from input images to obtain feature maps, and the backbone network includes five CBS modules, four C2f modules and a SPFF module. The neck network is configured to perform multi-scale feature fusion on the feature maps to obtain fused features and send the fused features to the head network, and the neck network includes five CBS modules, six C2f modules, three UnSample modules, six ConCat module and a CBAM module. The head network is configured to predict the input images, and the head network includes four detection heads.

Each CBS module is a combination of convolution-batch normalization-activation functions, and a most basic operation unit in the network model, and each CBS module is configured to extract and process features.

Each C2f module is a cross-scaling path structure, a lightweight module, and a main component of the backbone network and the neck network in the network model, and each C2f module is configured to enhance a gradient flow and multi-scale information of features.

Each ConCat module is a feature concatenation operation module, and configured to fuse features of different levels to adapt to target detection of different scales.

Each UnSample module is an upsampling operation module, and configured to scale low-resolution feature maps to high resolution, thereby to perform finer target detection.

The SPFF module is a spatial pyramid structure, and is configured to multi-scale pool feature maps to enhance a receptive field and robustness of features.

The CBAM module is a convolutional attention mechanism module, and is configured to adaptively adjust feature maps in both spatial and channel dimensions to improve performance and generalization ability of the network model.

### Embodiment 2

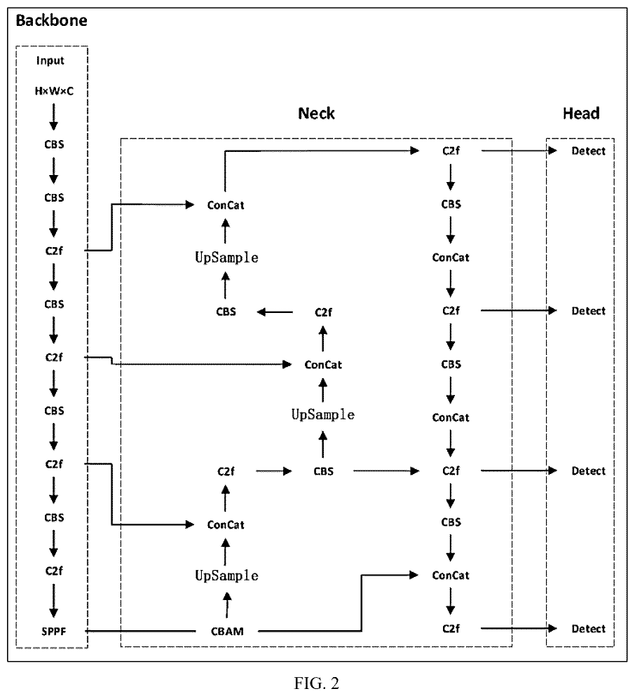

Furthermore, as shown in FIG. 2, the backbone network is configured to extract features from the input images to obtain the feature maps, and the backbone network includes the five CBS modules, the four C2f modules and the SPFF module. The backbone network first uses one of the CBS modules to convert the input images into the feature maps, then sequentially perform feature extraction through 4 feature extraction stages, i.e., the combination of the CBS modules and the C2f modules. The 4 feature extraction stages correspond to the 4 detection heads, respectively. Finally, the backbone network uses the SPPF module to enhance the receptive field of the features, thereby facilitating the multi-scale feature fusion of the neck network. The neck network is mainly configured to perform the multi-scale feature fusion on the feature maps and pass the fused features to the head network. The neck network includes the five CBS modules, the six C2f modules, the three UnSample modules, the six ConCat modules, and the CBAM module.

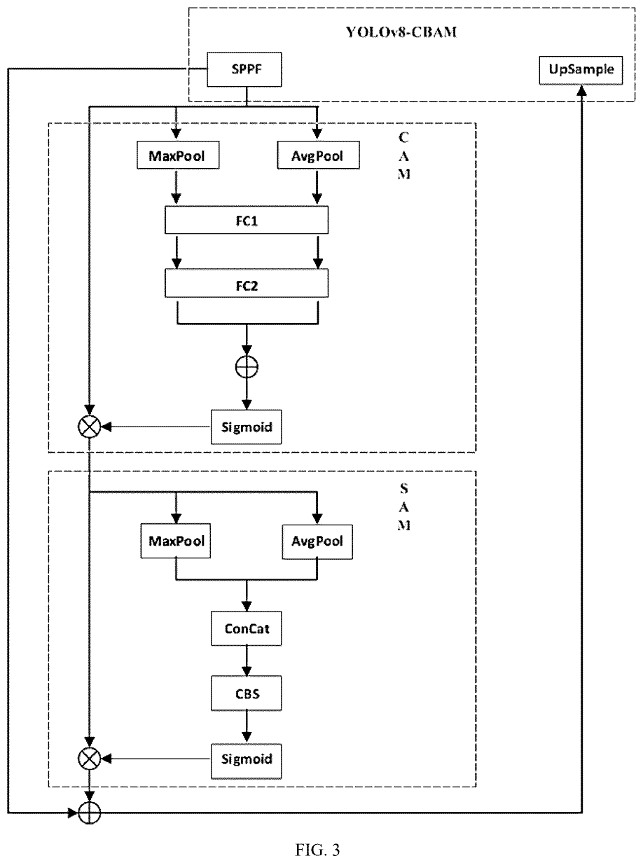

The neck network adopts a typical feature pyramid network structure, i.e., a feature pyramid network+path aggregation network (FPN+PAN) structure. A FPN layer transmits strong semantic features from top to bottom, while a PAN layer transmits strong localization features from bottom to top. Together, they perform parameter fusion from different backbone layers to different detection layers, ensuring that both target positional information and target category information are preserved to a greatest extent. At the same time, the neck network has the CBAM module added based on an original YOLOv8 network model. The CBAM module is a lightweight module, as shown in FIG. 3.

The CBAM module includes two independent sub-modules, which are a channel attention module (CAM) and a spatial attention module (SAM); the CAM focuses on important feature information, while the SAM focuses on the target position information. By adding the CBAM module to the neck network of the YOLOv8 model, it is possible to emphasize the important features and suppress general features, thereby improving detection accuracy. The head network has a detection head added based on the original YOLOv8 network model, so as to capture smaller feature information in defect areas of the hydro turbine top cover.

In the embodiment, each CBS module includes a convolution layer, a batch normalization layer connected with the convolution layer, and an activation function layer connected with the batch normalization layer. Each C2f module includes: two CBS modules, a spilt layer, three bottleneck layers, and a concatenate layer, one of the two CBS module is connected to the spilt layer, the spilt layer is connected to the three bottleneck layers, and the three bottleneck layers are connected to the concatenate layer, and the concatenate layer is connected to the other CBS module.

Furthermore, the classification loss in the step S4 is calculated by using a binary cross-entropy loss function, as shown in the following formula:

$${LOSS}_{BCE} = - ω [ {y}_{n} log {x}_{n} + ( 1 - {y}_{n} ) log ( 1 - {x}_{n} ) ] ,$$

where ω represents a weight, yₙ represents a true value of a n-th sample, and xₙ represents a predicted value of the n-th sample.

Furthermore, the localization loss LOSS_{DFL} is calculated by using the DFL loss function and the another localization loss LOSS_{CIOU} is calculated by using the CIOU loss function, as follows:

$${LOSS}_{DFL} = - ( {y}_{n + 1} - {x}_{n} ) log ( {φ}_{n} ) + ( {x}_{n} - {y}_{n} ) log ( {φ}_{n + 1} ) ] \\ {φ}_{n} = \frac{{y}_{n + 1} - {x}_{n}}{{y}_{n + 1} - {y}_{n}} \\ {φ}_{n + 1} = \frac{{x}_{n} - {y}_{n}}{{y}_{n + 1} - {y}_{n}} \\ {LOSS}_{CIOU} = IOU - \frac{{p}^{2} ( b , {b}^{gt} )}{{c}^{2}} - α v \\ α = v \frac{v}{1 - IOU} \\ v = \frac{4}{{π}^{2}} {( arc tan \frac{{w}^{gt}}{{h}^{gt}} - arc tan \frac{w}{h} )}^{2}$$

where yₙ represents the true value of the n-th sample, yₙ₊₁ represents a true value of a n+1-th sample, xₙ represents the predicted value of the n-th sample, IOU represents an intersection over union between a true box and a predicted box, b represents a center point position of the predicted box, b^{gt} represents a center point position of the true box, p represents a Euclidean distance between the center points of the two boxes (i.e., the predicted box and the true box), c represents a diagonal distance of a smallest bounding box that can contain both the two boxes, a represents a trade-off parameter, v represents a similarity of aspect ratios of the two boxes, i.e., a parameter shows whether the aspect ratios of the regression box (i.e., the predicted box) and the true box are consistent, w^{gt} represents a width of the true box, h^{gt} represents a height of the true box, w represents a width of the predicted box, and h represents a height of the predicted box.

The embodiments listed above are merely preferred technical solutions of the disclosure and should not be construed as limiting the disclosure. The embodiments in the disclosure and the features in the embodiments can be freely combined with each other without conflict. The scope of protection of the disclosure should be defined by the technical solutions recorded in the claims, including equivalent substitution schemes of the technical features recorded in the claims. That is, equivalent substitution improvements within this scope are also within the protection scope of the disclosure.

What is claimed is:

1. A method for detecting defects in a hydro turbine top cover based on an improved you-only-look-once version 8 (YOLOv8) model, comprising:
S1, processing hydro turbine top cover defect images which are collected to obtain a hydro turbine top cover defect data set;
S2, dividing the hydro turbine top cover defect data set into a train set, a validation set and a test set based on a ratio of 6:2:2;
S3, constructing a network model for detecting the defects in the hydro turbine top cover based on YOLOv8-convolutional block attention module (YOLOv8-CBAM);
S4, training the network model for detecting the defects in the hydro turbine top cover based on the YOLOv8-CBAM, specifically comprising:
inputting the hydro turbine top cover defect data set in the step S1 into the network model for training, wherein a total loss function of the network model comprises: a binary cross-entropy (BCE) loss, a distance-weighted flight (DFL) loss, and a complete intersection over union (CIOU) loss, and a calculation formula of the total loss function is as follows:
$$LOSS = {λ}_{1} {LOSS}_{BCE} + {λ}_{2} {LOSS}_{DFL} + {λ}_{3} {LOSS}_{CIOU}$$
where LOSS_{BCE} represents a classification loss, LOSS_{DFL} represents a localization loss, LOSS_{CIOU} represents another localization loss, λ₁ represents a weight of the BCE loss in a total loss for the classification loss, λ₂ represents a weight of the DFL loss in the total loss for the localization loss, and λ₃ represents a weight of the CIOU loss in the total loss for the another localization loss;
S5, generating the improved YOLOv8 model after the step S4; and
S6, detecting the defects in the hydro turbine top cover based on the improved YOLOv8 model.

2. The method for detecting the defects in the hydro turbine top cover based on the improved YOLOv8 model as claimed in claim 1, wherein in the step S1, the processing hydro turbine top cover defect images comprises:
cropping the hydro turbine top cover defect images which are taken on-site to obtain cropped images, and expanding the cropped images by image enhancement techniques to obtain the hydro turbine top cover defect data set.

3. The method as claimed in claim 1, wherein the classification loss in the step S4 is calculated by using a binary cross-entropy loss function, as follows:
$${LOSS}_{BCE} = - ω [ {y}_{n} log {x}_{n} + ( 1 - {y}_{n} ) log ( 1 - {x}_{n} ) ]$$
where ω represents a weight, yₙ represents a true value of a n-th sample, and xₙ represents a predicted value of the n-th sample.

4. The method as claimed in claim 1, wherein the localization loss LOSS_{DFL} is calculated by using a DFL loss function, the another localization loss LOSS_{CIOU} is calculated by using a CIOU loss function, and the localization loss LOSS_{DFL} and the another localization loss LOSS_{CIOU} are as follows:
$${LOSS}_{DFL} = - ( {y}_{n + 1} - {x}_{n} ) log ( {φ}_{n} ) + ( {x}_{n} - {y}_{n} ) log ( {φ}_{n + 1} ) ] \\ {φ}_{n} = \frac{{y}_{n + 1} - {x}_{n}}{{y}_{n + 1} - {y}_{n}} , {φ}_{n + 1} = \frac{{x}_{n} - {y}_{n}}{{y}_{n + 1} - {y}_{n}} \\ {LOSS}_{CIOU} = IOU - \frac{{p}^{2} ( b , {b}^{gt} )}{{c}^{2}} - α v \\ α = v \frac{v}{1 - IOU} \\ v = \frac{4}{{π}^{2}} {( arc tan \frac{{w}^{gt}}{{h}^{gt}} - arc tan \frac{w}{h} )}^{2}$$
where yₙ represents a true value of a n-th sample, yₙ₊₁ represents a true value of a n+1-th sample, xₙ represents a predicted value of a n-th sample, IOU represents an intersection over union between a true box and a predicted box, b represents a center point position of the predicted box, b^{gt} represents a center point position of the true box, p represents a Euclidean distance between the center points of the predicted box and the true box, c represents a diagonal distance of a smallest bounding box that contains both the predicted box and the true box, α represents a trade-off parameter, y represents a similarity of aspect ratios of the predicted box and the true box, w^{gt} represents a width of the true box, h^{gt} represents a height of the true box, w represents a width of the predicted box, and h represents a height of the predicted box.

5. The method for detecting the defects in the hydro turbine top cover based on the improved YOLOv8 model as claimed in claim 1, wherein in the step S3, the network model for detecting the defects in the hydro turbine top cover based on the YOLOv8-CBAM comprises: a backbone network, a neck network and a head network.

6. The method for detecting the defects in the hydro turbine top cover based on the improved YOLOv8 model as claimed in claim 5, wherein in the step S3,
the backbone network is configured to extract features from input images to obtain feature maps, and the backbone network comprises five convolution-batch normalization-sigmoid (CBS) modules, four cross stage partial network fusion (C2f) modules and a spatial pyramid pooling fast (SPFF) module;
the neck network is configured to perform multi-scale feature fusion on the feature maps to obtain fused features and send the fused features to the head network, and the neck network comprises five CBS modules, six C2f modules, three upsampling (UnSample) modules, six concatenation (ConCat) module and a CBAM module; and
the head network is configured to predict the input images, and the head network comprises four detection heads;
wherein each CBS module is a combination of convolution-batch normalization-activation functions, and a most basic operation unit in the network model, and each CBS module is configured to extract and process features;
each C2f module is a cross-scaling path structure, a lightweight module, and a main component of the backbone network and the neck network in the network model, and each C2f module is configured to enhance a gradient flow and multi-scale information of features;
each ConCat module is a feature concatenation operation module, and configured to fuse features of different levels to adapt to target detection of different scales;
each UnSample module is an upsampling operation module, and configured to scale low-resolution feature maps to high resolution, thereby to perform finer target detection;
the SPFF module is a spatial pyramid structure, and is configured to multi-scale pool feature maps to enhance a receptive field and robustness of features; and
the CBAM module is a convolutional attention mechanism module, and is configured to adaptively adjust feature maps in both spatial and channel dimensions to improve performance and generalization ability of the network model.

7. The method as claimed in claim 6, wherein the backbone network is configured to convert the input images into the feature maps via one of the five CBS modules, perform feature extraction via remaining four of the five CBS modules and the four C2f modules, and enhance the receptive field of the features via the SPPF module.

8. The method as claimed in claim 6, wherein the neck network adopts a feature pyramid network+path aggregation network (FPN+PAN) structure.

9. The method as claimed in claim 6, wherein the CBAM module comprises a channel attention module (CAM) and a spatial attention module (SAM), the CAM is configured to focus on feature information, and the SAM is configured to focus on target position information.

10. A method for detecting defects in a hydro turbine top cover based on an improved YOLOv8 model, comprising:
S1, collecting hydro turbine top cover defect images and processing the hydro turbine top cover defect images to obtain a hydro turbine top cover defect data set;
S2, dividing the hydro turbine top cover defect data set into a train set, a validation set and a test set based on a ratio of 6:2:2;
S3, training a network for detecting the defects in the hydro turbine top cover based on YOLOv8-CBAM to obtain a YOLOv8-CBAM model as the improved YOLOv8 model, specifically comprising:
inputting the hydro turbine top cover defect data set into the network for training, wherein a total loss function of the YOLOv8-CBAM model comprises: a BCE loss, a DFL loss, and a CIOU loss, and a calculation formula of the total loss function is as follows:
$$LOSS = {λ}_{1} {LOSS}_{BCE} + {λ}_{2} {LOSS}_{DFL} + {λ}_{3} {LOSS}_{CIOU}$$
where LOSS_{BCE} represents a classification loss, LOSS_{DFL} represents a localization loss, LOSS_{CIOU} represents another localization loss, λ₁ represents a weight of the BCE loss in a total loss for the classification loss, λ₂ represents a weight of the DFL loss in the total loss for the localization loss, and λ₃ represents a weight of the CIOU loss in the total loss for the another localization loss;
wherein the classification loss LOSS_{BCE} is calculated by using a binary cross-entropy loss function, as follows:
$${LOSS}_{BCE} = - ω [ {y}_{n} log {x}_{n} + ( 1 - {y}_{n} ) log ( 1 - {x}_{n} ) ]$$
where ω represents a weight, yₙ represents a true value of a n-th sample, and xₙ represents a predicted value of the n-th sample;
wherein the localization loss LOSS_{DFL} is calculated by using a DFL loss function as follows:
$${LOSS}_{DFL} = - ( {y}_{n + 1} - {x}_{n} ) log ( {φ}_{n} ) + ( {x}_{n} - {y}_{n} ) log ( {φ}_{n + 1} ) ] \\ {φ}_{n} = \frac{{y}_{n + 1} - {x}_{n}}{{y}_{n + 1} - {y}_{n}} , {φ}_{n + 1} = \frac{{x}_{n} - {y}_{n}}{{y}_{n + 1} - {y}_{n}}$$
where yₙ₊₁ represents a true value of a n+1-th sample;
wherein the another localization loss LOSS_{CIOU} is calculated by using a CIOU loss function as follows:
$${LOSS}_{CIOU} = IOU - \frac{{p}^{2} ( b , {b}^{gt} )}{{c}^{2}} - α v \\ α = v \frac{v}{1 - IOU} \\ v = \frac{4}{{π}^{2}} {( arc tan \frac{{w}^{gt}}{{h}^{gt}} - arc tan \frac{w}{h} )}^{2}$$
where IOU represents an intersection over union between a true box and a predicted box, b represents a center point position of the predicted box, b^{gt} represents a center point position of the true box, p represents a Euclidean distance between the center points of the predicted box and the true box, c represents a diagonal distance of a smallest bounding box that contains both the predicted box and the true box, a represents a trade-off parameter, v represents a similarity of aspect ratios of the predicted box and the true box, w^{gt} represents a width of the true box, h^{gt} represents a height of the true box, w represents a width of the predicted box, and h represents a height of the predicted box; and
S4, detecting the defects in the hydro turbine top cover based on the improved YOLOv8 model.

11. The method as claimed in claim 10, wherein in the step S1, the processing hydro turbine top cover defect images comprises:
cropping the hydro turbine top cover defect images which are taken on-site to obtain cropped images, and expanding the cropped images by image enhancement techniques to obtain the hydro turbine top cover defect data set.

12. The method as claimed in claim 10, wherein in the step S3, the network for detecting the defects in the hydro turbine top cover based on the YOLOv8-CBAM comprises: a backbone network, a neck network and a head network which are sequentially connected in that order.

13. The method as claimed in claim 12, wherein
the backbone network is configured to extract features from input images to obtain feature maps, and the backbone network comprises five CBS modules, four C2f modules and a SPFF module;
the neck network is configured to perform multi-scale feature fusion on the feature maps to obtain fused features and send the fused features to the head network, and the neck network comprises five CBS modules, six C2f modules, three UnSample modules, six ConCat module and a CBAM module; and
the head network is configured to predict the input images, and the head network comprises four detection heads.

14. The method as claimed in claim 13, wherein the backbone network is configured to convert the input images into the feature maps by one of the five CBS modules, perform feature extraction by remaining four of the five CBS modules and the four C2f modules, and enhance the receptive field of the features by the SPPF module.

15. The method as claimed in claim 13, wherein the neck network adopts a FPN+PAN structure to transmit semantic features from top to bottom and to transmit localization features from bottom to top.

16. The method as claimed in claim 13, wherein the CBAM module comprises a CAM and a SAM, the CAM is configured to focus on feature information, and the SAM is configured to focus on target position information.

17. A method for detecting defects in a hydro turbine top cover based on an improved YOLOv8 model, comprising:
S1, collecting hydro turbine top cover defect images, and processing the hydro turbine top cover defect images to obtain a hydro turbine top cover defect data set, specifically comprising:
cropping the hydro turbine top cover defect images to obtain cropped images, and expanding the cropped images by image enhancement techniques to obtain the hydro turbine top cover defect data set;
S2, dividing the hydro turbine top cover defect data set into a train set, a validation set and a test set based on a ratio of 6:2:2;
S3, constructing a network for detecting the defects in the hydro turbine top cover based on YOLOv8-CBAM, wherein the network for detecting the defects in the hydro turbine top cover based on the YOLOv8-CBAM comprises: a backbone network, a neck network and a head network;
S4, training the network for detecting the defects in the hydro turbine top cover based on the YOLOv8-CBAM to obtain a YOLOv8-CBAM model as the improved YOLOv8 model, specifically comprising:
inputting the hydro turbine top cover defect data set into the network for training, wherein a total loss function of the YOLOv8-CBAM model comprises: a BCE loss, a DFL loss, and a CIOU loss, and a calculation formula of the total loss function is as follows:
$$LOSS = {λ}_{1} {LOSS}_{BCE} + {λ}_{2} {LOSS}_{DFL} + {λ}_{3} {LOSS}_{CIOU} ,$$
where LOSS_{BCE} represents a classification loss, LOSS_{DFL} represents a localization loss, LOSS_{CIOU} represents another localization loss, λ₁ represents a weight of the BCE loss in a total loss for the classification loss, λ₂ represents a weight of the DFL loss in the total loss for the localization loss, and λ₃ represents a weight of the CIOU loss in the total loss for the another localization loss; and
S5, detecting the defects in the hydro turbine top cover based on the improved YOLOv8 model.

18. The method as claimed in claim 17, wherein the backbone network is configured to extract features from input images to obtain feature maps, and the backbone network comprises five CBS modules, four C2f modules and a SPFF module; the neck network is configured to perform multi-scale feature fusion on the feature maps to obtain fused features and send the fused features to the head network, and the neck network comprises five CBS modules, six C2f modules, three UnSample modules, six ConCat module and a CBAM module; and the head network is configured to predict the input images, and the head network comprises four detection heads; and
wherein each CBS module comprises: a convolution layer, a batch normalization layer connected with the convolution layer, and an activation function layer connected with the batch normalization layer; and each C2f module comprises: two CBS modules, a spilt layer, three bottleneck layers, and a concatenate layer, one of the two CBS module is connected to the spilt layer, the spilt layer is connected to the three bottleneck layers, and the three bottleneck layers are connected to the concatenate layer, and the concatenate layer is connected to the other CBS module.

19. The method as claimed in claim 17, wherein the neck network adopts a FPN+PAN structure.

20. The method as claimed in claim 17, wherein the CBAM module comprises a CAM and a SAM, the CAM is configured to focus on feature information, and the SAM is configured to focus on target position information.
